(19) United States
(12) Patent Application Publication
(10) Pub. No.: US 2006/0022559 A1
(43) Pub. Date: Feb. 2, 2006

(54) Collapsible shelving device

(76) Inventor: Frank Mallen, Dollard-des-Ormeaux (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/902,099

(22) Filed: Jul. 30, 2004

(51) Int. Cl. A47F 1/00; B65G 11/00

(52) U.S. Cl. 312/60

(57) ABSTRACT

A shelving device comprises a pair of soft vertical panels and shelves. Each shelf is interconnected at a first end to a first of the vertical panels, and at a second end to a second of the vertical panels, so as to be erectable from a collapsed position of the shelving device, in which the shelves are piled upon one another, and a set-up position of the shelving device, in which the shelves are spaced from one another by the vertical panels each being extended in a plane Posts are releasably secured to the shelving device to support the vertical panels extended in the plane. The posts are removed to dismount the shelving device to the collapsed position, in which the shelving device is portable.

### BACKGROUND OF THE INVENTION

1. Field of the Invention

The present invention generally relates to camping equipment and, more particularly, to a portable shelving device.

2. Background Art

Whether it be in sports, leisure, or work-related activities, temporary housing is commonplace. Tents, rudimentary shelters and the like are associated with wilderness, in sport/leisure activities such as camping, and work-related activities, such as cutters, tree planters. Although tents and shelters are used on a temporary basis, campers may stay on a same site for several days.

These activities have evolved to enhance the comfort of campers, especially when camping trips are over a few nights. Therefore, domestic tools that used to be confined to the comfort of homes, have now reached the wilderness, and have become essential parts of camping. In addition to classic camping items such as flashlights, insect repellent, campers often carry around reading lights, books and other reading material, tissue and toilet paper, alarms, cameras, portable music players and a plurality of such accessories.

However, tents and shelters remain rudimentary, and often simply consist of a floor surrounded with walls. Therefore, the above-enumerated camping accessories are typically all over the floor, if not all-mixed up in a bag. This is a nuisance to campers in many instances. For example, campers may lose some time and sleep trying to find accessories such as the flashlight, without which the camper may have problems exiting the tent at dusk.

### SUMMARY OF INVENTION

It is an aim of the present invention to provide a novel shelving device for camping.

It is a further aim of the present invention to provide a shelving device that is erectable to provide shelving surface, and collapsible so as to be portable.

It is a still further aim of the present invention to provide a method of erecting a shelving device.

Therefore, in accordance with the present invention, there is provided a shelving device comprising: a pair of soft vertical panels; shelves, each interconnected at a first end to a first of the vertical panels, and at a second end to a second of the vertical panels, so as to be erectable from a collapsed position of the shelving device, in which the shelves are piled upon one another, and a set-up position of the shelving device, in which the shelves are spaced from one another by the vertical panels each being extended in a plane; and posts releasably secured to the shelving device to support the vertical panels extended in the plane; whereby the posts are removed to dismount the shelving device to the collapsed position, in which the shelving device is portable.

Further in accordance with the present invention, there is provided a method for erecting a shelving device having shelves and a pair of side panels secured to opposed ends of the shelves, one of the shelves and the side panels consisting of a non-rigid material, another of the shelves and the side panels consisting of a rigid material, comprising the steps of: lifting the shelving device such that the side panels and the shelves are each extended to a plane; and securing posts to the shelving device to maintain the side panels and the shelves extended; whereby the shelving device is erected.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a perspective view of a collapsible shelving device in accordance with a preferred embodiment of the present invention, in a set-up configuration and having a front panel thereof folded open;

FIG. 2 is a perspective view of the collapsible shelving device, in the set-up configuration and having a rear panel thereof folded open;

FIG. 3 is a left-side elevation view of the collapsible shelving device, in the set-up configuration;

FIG. 4 is a right-side elevation view of the collapsible shelving device, in the set-up configuration;

FIG. 5 is an enlarged view of a longitudinal pocket of the collapsible shelving device, partially open to accommodate a post;

FIG. 6 is a rear side view of the collapsible shelving device in its set-up configuration, with the rear panel closed;

FIG. 7 is a perspective view of the collapsible shelving device, in its collapsed configuration; and

FIG. 8 is a perspective view of the collapsible shelving device in its collapsed configuration, as received in its transportation bag.

### DESCRIPTION OF THE PREFERRED EMBODIMENTS

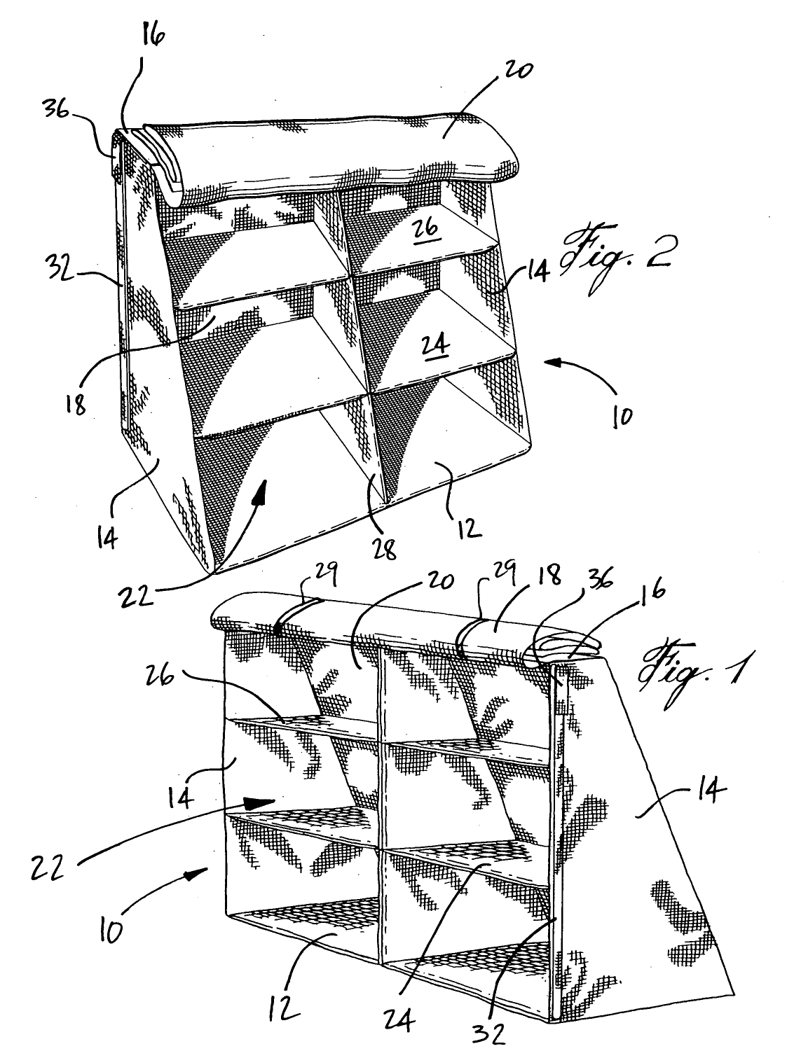

Referring to the drawings and, more particularly, to FIG. 1 a collapsible shelving device in accordance with a preferred embodiment of the present invention is generally shown at 10, in its set-up configuration.

In its set-up configuration, the shelving device 10 has a base panel 12, a pair of side panels 14, a top panel 16, a front panel 18 folded away in FIG. 1, and a rear panel 20. The above-described panels together form an inner cavity 22 of the shelving device 10, to be used as described hereinafter for storage of items within the shelving device 10. Shelves 24 and 26 are accommodated within the cavity 22, and are split by a central upstanding panel 28.

The embodiment illustrated in FIG. 1 defines six compartments with the shelves 24 and 26 and the central panel 28. It is contemplated to provide the shelving device 10 with other shelving configurations, to have larger and/or smaller compartments, more or less shelves, etc. . .

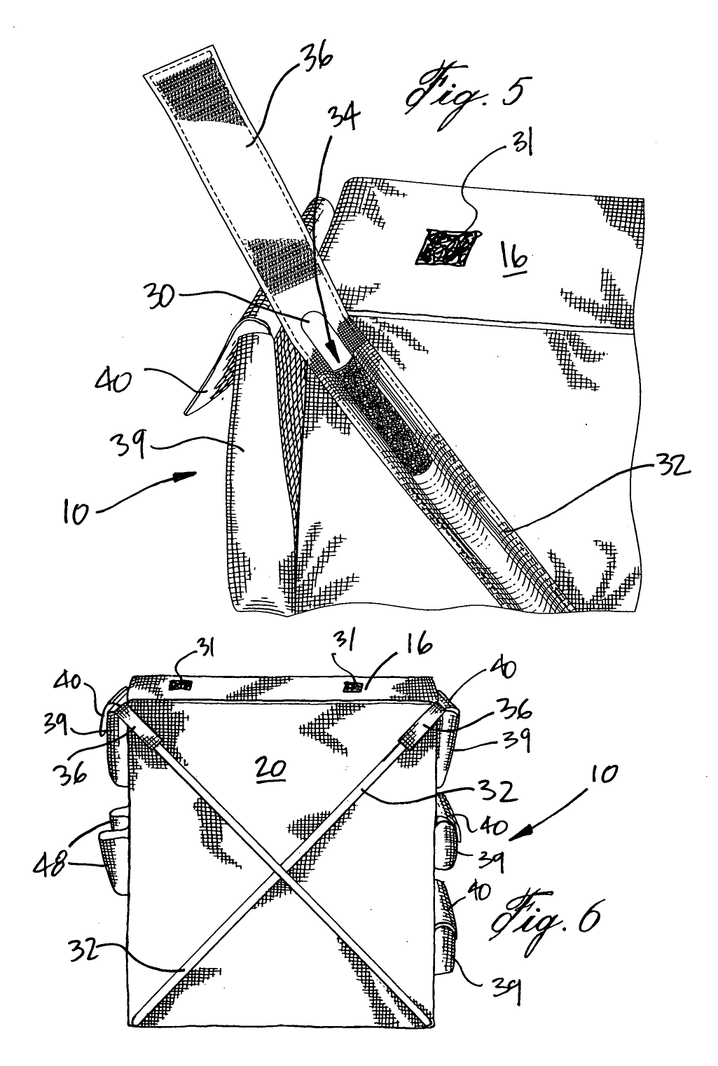

As shown in FIG. 1, the front panel 18 has been flipped away from the front face of the shelving device 10 so as to expose the shelving compartments of the inner cavity 22. Straps 29 are used to retain the front panel 18 in its flipped-away position illustrated in FIG. 1. The straps 29 each have a first end secured to an underface of the top panel 16, and an opposed end releasably secured to a top face of the top panel 16. As shown in FIGS. 5 and 6, a piece 31 of Velcro™ has been provided to cooperate with the straps 29 (FIG. 1, which have complementary pieces of Velcro™), to secure the front panel 18 in its flipped-away position (FIG. 1).

The front panel 18 preferably consists of a soft material (e.g., non-rigid or semi-rigid), such that it may be folded onto the top panel 16, as shown in FIG. 1. As shown in FIG. 2, the front panel 18 covers the shelving compartments. A fastening system, such as a zip fastener, Velcro™, slide fastener or the like, is typically provided for the front panel 18 to be releasably secured to the front face of the shelving device 10, as illustrated in FIG. 2.

Similarly, as shown in FIGS. 1 and 2, the rear panel 20 may cover the rear face of the shelving compartments (FIG. 1), or be folded away to expose the shelving compartments (FIG. 2). A fastening system, such as a zip fastener, Velcro™, slide fastener or the like, is typically provided for the rear panel 20 to be releasably secured to the rear face the shelving device 10, as illustrated in FIG. 2. Both the front panel 18 and the rear panel 20 may cover the shelving compartment at the same time, so as to conceal accessories within the shelving compartment. A locking device may be used (e.g., with the zip fastener), to lock the panels 18 and 20 in their covering positions.

The shelving device 10 of the present invention is collapsible, in that it may be collapsed to be portable, such as illustrated in FIG. 8. Therefore, in an embodiment of the present invention, some of the vertical panels (i.e., side panels 14, front panel 18, rear panel 20) are soft (i.e., non-rigid or semi-rigid), as opposed to the horizontal panels (i.e., base panel 12, top panel 16, and shelves 24 and 26), which are generally rigid. It is pointed out that the central panel 28 may be either soft or rigid. In the event that the central panel 28 is rigid, the top panel 16 in the set-up configuration of FIG. 1 will be better adapted to support items. Moreover, for the central panel 28 to be rigid, it must be separated in segments pivotally connected to the horizontal panels (i.e., base panel. 12, top panel 16, and shelves 24 and 26) to allow the shelving device 10 to reach its collapsed configuration.

The structural integrity of the shelving device 10, in its set-up configuration of FIGS. 1 and 2, is obtained by the use of posts (i.e., rods, sticks, telescopic poles, segmented tent poles or the like), one of which is partly visible at 30 in FIG. 5, in combination to the rigidity of the horizontal panels.

The embodiment illustrated in FIGS. 1 to 8 has four such posts 30. Two longitudinal pockets 32 are provided onto the side panels 14, adjacent to a front face of the collapsible shelving device 10, whereas two longitudinal pockets 32 are provided onto the rear panel 20 (FIG. 6). Each of the longitudinal pockets 32 accommodates a post 30. The posts 30 are snuggly received in the pockets 32, so as to stiffen the side panels 14, which will support the top panel 16 and the shelves 24 and 26.

The longitudinal pockets 32 each have an open end 34 (one of which is shown in FIG. 5) through which the respective post 30 is accommodated. A flap 36 is provided to close off the open end 34. In the embodiment of FIG. 5, complementary Velcro™ pieces are used to secure the flap 36 to the pocket 32, as shown with the flap 36 being separated from the pocket 32. Alternative securing means (e.g., press-buttons, hooks and the like) could also be used. Moreover, alternatives to the longitudinal pockets 32, such as end catches and hooks (i.e., as found on tents), can be used.

As seen in FIG. 6, the two longitudinal pockets 32 on the rear panel 20 are in a cross-over bracing configuration, to define an X-shape on the rear panel 20. The combination of the posts 30 (within their respective pockets 32), with the rigid horizontal panels (e.g., shelves 24 and 26, and top panel 16), ensures the collapsible shelving device 10 remains in its upstanding set-up configuration, capable of withstanding the load of accessories in the shelving compartments.

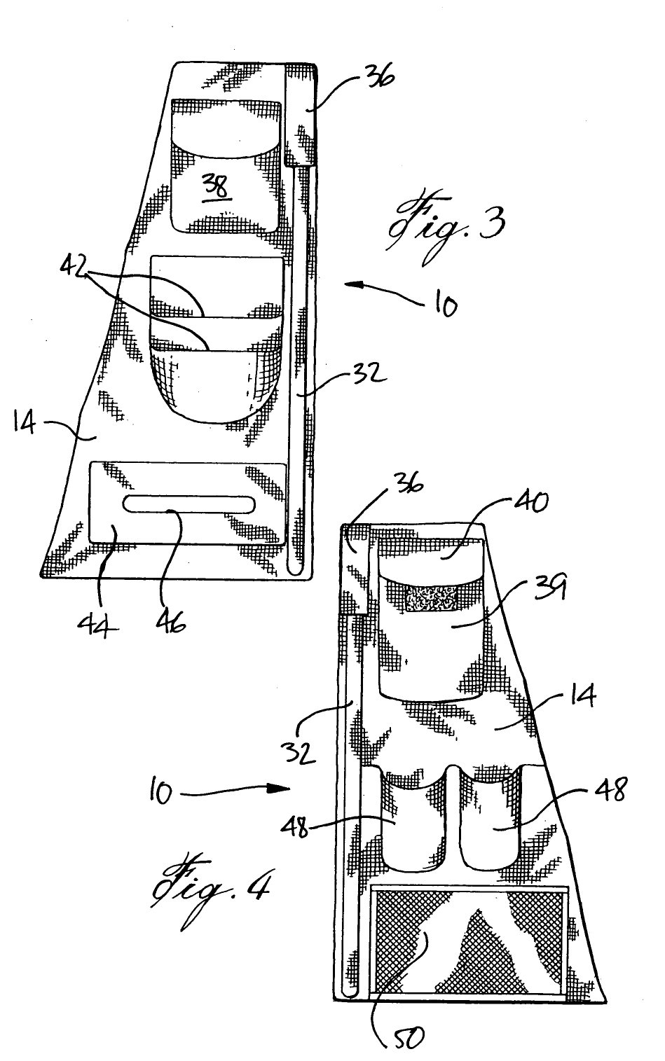

Referring to FIGS. 3 and 4, the side panels 14 are optionally provided with various storage pockets. Referring to FIG. 3, pocket 38 and superposed pockets 42 are provided to offer a camper multiple storage possibilities. A tissue receiving pocket 44 has a slit 46 through which tissues (i.e., from a tissue dispensing package) may be dispensed.

Referring to FIG. 4, a pocket 39, with a closeable flap 40, is provided adjacent the top panel 16, so as to conceal items therein. Pockets 48 are provided to accommodate beverage containers, such as bottles and cans. A mesh pocket is illustrated at 50, and is typically used for the storage of small items (e.g., coins), and papers.

It is pointed out that the shelving device 10 of the present invention may be provided with various storage pocket configuration. For instance, the embodiments of FIGS. 1 and 2 of the shelving device 10 do not have any storage pockets on their side panels 14. On the other hand, the embodiment of FIG. 6 has a plurality of the pocket 39/flap 40 combination. The embodiment of FIGS. 3 and 4 has a variety of storage pockets, as described above.

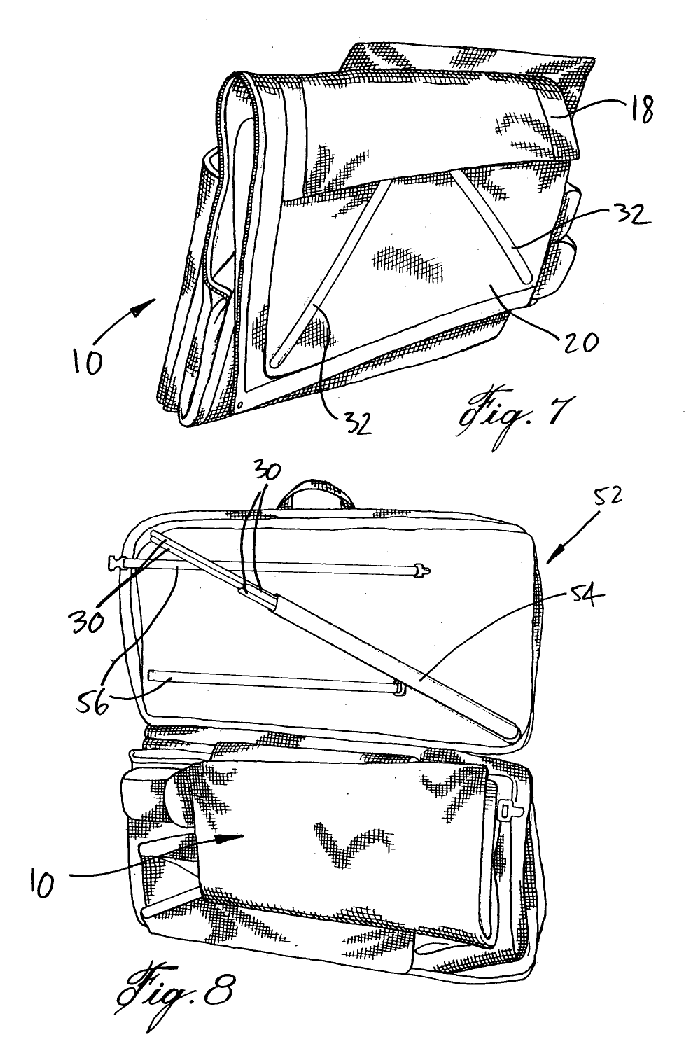

Referring to FIG. 7, the shelving device 10 is shown in its collapsed configuration. In order to erect the shelving device 10 to its set-up configuration of FIGS. 1 to 6, the shelving device 10 is manually lifted to take shape into the set-up configuration by the action of gravity, such that the side panels 14 are each extended to a plane (FIGS. 1 and 2). The posts 30 are each slid into respective ones of the longitudinal pockets 32, through the open ends 34 (FIG. 5) and the flaps 36 are closed. It is preferred to secure the rear panel 20 to a remainder of the shelving device 10 before inserting the posts 30 in the longitudinal pockets 32 of the rear panel 20.

In order to dismount the shelving device 10 to its collapsed configuration (FIG. 7), the posts 30 (FIG. 5) are withdrawn from the longitudinal pockets 32 such that the rigid panels (i.e., the base panel 12, the top panel 16, the shelves 24 and 26) collapse onto one another. As illustrated in FIG. 7, the front panel 18 and the rear panel 20 may be used to wrap around the rigid panels, so as to obtain the compact collapsed configuration illustrated. However, the front panel 18 and the rear panel 20 must be separated from the remainder of the shelving device 10 (e.g., unzipped) beforehand.

It is pointed out that the posts 30 that are received in the longitudinal pockets 32 of the rear panel 20 (FIG. 6) are longer than the posts. 30 that are received in the longitudinal pockets 32 of the side panels 14 (FIGS. 3 and 4). Therefore, the posts 30 may be identified (e.g., color coded, written code), to ensure the posts 30 are used with the appropriate longitudinal pockets 32.

Referring to FIG. 2, the shelving device 10 is shown in its set-up configuration, with the rear panel 20 flipped opened to expose the storage compartment. It is pointed out that the posts 30 of the rear panel 20 (FIG. 5) must be removed in order for the rear panel 20 to be flipped open as shown in FIG. 2. This leaves only the two posts on the side panels 14 to support the shelving device 10. These two posts within the two longitudinal pockets 32 of the side panels 14 do not provide enough support to maintain the shelving device 10 in its set-up configuration if the posts 30 of the rear panel 20 are removed, as the rear panel 20 must be shut and reinforced by posts to maintain its structural integrity. The shelving device 10 loses some stability with the absence of the posts 30 in the rear panel 20, whereby additional posts must be used to compensate for the absence of posts in the rear panel 20. For instance, a pair of longitudinal pockets, such as the longitudinal pockets 32, could be provided bordering the rear diagonal edge of the side panels 14, receive posts so as to enable the shelving device 10 to be self-supporting in the embodiment of FIG. 2.

It is pointed out that the optional trapezoid shape of the side panels 14 ensures that the shelving device 10 efficiently occupies available volume in a tent. More specifically, a tent typically has slanted walls, whereby the collapsible shelving device 10 may be backed up to the wall of a tent within loss of space between the shelving device 10 and the tent.

Referring to FIG. 8, the shelving device 10 is optionally provided with a bag 52 so as to be portable. The bag 52 has a longitudinal pocket 54 large enough to accommodate all posts 30. Moreover, the bag 52 is provided with various straps, such as straps 56, to allow for other uses of the bag 52.

Although the shelving device 10 of the preferred embodiment of the present invention has rigid horizontal panels (i.e., base panel 12, top panel 16, shelves 24 and 26) for soft vertical panels (i.e., side panels 14, and central upstanding panel 28), it is contemplated to provide the shelving device 10 with an opposite configuration, namely with rigid vertical panels and soft horizontal panels. In such an embodiment, the posts 30 of the side panels 14 would rather be used to maintain the horizontal panels extended to a plane. For instance, the base panel 12 and the top panel 16 could each have a longitudinal pocket 32 therefor.

It is within the ambit of the present invention to cover any obvious modifications of the embodiments described herein, provided such modifications fall within the scope of the appended claims.

1. A shelving device comprising:
a pair of soft vertical panels;
shelves, each interconnected at a first end to a first of the vertical panels, and at a second end to a second of the vertical panels, so as to be erectable from a collapsed position of the shelving device, in which the shelves are piled upon one another, and a set-up position of the shelving device, in which the shelves are spaced from one another by the vertical panels each being extended in a plane; and
posts releasably secured to the shelving device to support the vertical panels extended in the plane;
whereby the posts are removed to dismount the shelving device to the collapsed position, in which the shelving device is portable.

2. The shelving device according to claim 1, further comprising a top panel interconnected to a top end of each of the vertical panels so as to be spaced from and generally parallel to the shelves.

3. The shelving device according to claim 2, further comprising a first panel secured to a front edge of the top panel, and extending downwardly so as to cover a front access to the shelves, the first panel being releasably securable to front edges of the vertical panels.

4. The shelving device according to claim 3, further comprising a second panel secured to a rear edge of the top panel, and extending downwardly so as to cover a rear access to the shelves, the first panel being releasably securable to rear edges of the vertical panels.

5. The shelving device according to claim 1, wherein the vertical panels each have a trapezoid shape, such that the shelving device has a slanted face adapted to be opposed to a slanted wall of a tent.

6. The shelving device according to claim 1, wherein the vertical panels have pockets thereon.

7. The shelving device according to claim 1, wherein the posts are received in longitudinal pockets defined on the vertical panels.

8. The shelving device according to claim 2, further comprising a central vertical panel between the soft vertical panels, the central vertical panel separating each of the shelves in a pair of shelve portions in the set-up position of the shelving device.

9. The shelving device according to claim 8, wherein the central vertical panel consists of a plurality of rigid panel segments pivotally secured to the shelves and to the top panel, so as to support the top panel in the set-up position of the shelving device.

10. A method for erecting a shelving device having shelves and a pair of side panels secured to opposed ends of the shelves, one of the shelves and the side panels consisting of a non-rigid material, another of the shelves and the side panels consisting of a rigid material, comprising the steps of:
lifting the shelving device such that the side panels and the shelves are each extended to a plane; and
securing posts to the shelving device to maintain the side panels and the shelves extended;
whereby the shelving device is erected.

11. The method according to claim 10, further comprising a step of securing a panel to the shelving device. to cover the shelves prior to securing the posts to the shelving device.
